(19) United States
(12) Patent Application Publication
(10) Pub. No.: US 2012/0263775 A1
(43) Pub. Date: Oct. 18, 2012

(54) PRODUCTION OF PESTICIDE GRANULATES IN A SPOUTED BED APPARATUS

(75) Inventors: Stefan Blei, Mannheim (DE); Karl-Heinrich Schneider, Kleinkarlbach (DE); Hans-Michael Fricke, Limburgerhof (DE); Albert Werner, Bondorf (DE)

(73) Assignee: BASF SE, Ludwigshafen (DE)

(21) Appl. No.: 13/504,530

(22) PCT Filed: Oct. 25, 2010
(86) PCT No.: PCT/EP2010/066023

§ 371 Date: Jun. 28, 2012

(30) Foreign Application Priority Data
Oct. 27, 2009 (EP) 09174194.2

(51) Int. Cl. B02C 23/18; A01N 43/56; A01P 13/00; A01P 3/00; A01P 7/04; A01P 5/00; A01N 43/40; A01N 25/26

(52) U.S. Cl. 424/417; 514/355; 241/15

(57) ABSTRACT

The present invention relates to a method for producing granules comprising a pesticide, comprising the spraying-on of a pesticide-containing spray liquid in the region of a near-circular gas/material stream of a spouted-bed apparatus onto the particle surface of the material, and the drying and granulation in the gas stream. Furthermore, the invention relates to granules comprising a pesticide, obtainable by said method, where the granules have a roundness of at least 0.85.

The present invention relates to a method for producing granules comprising a pesticide, comprising the spraying-on of a pesticide-containing spray liquid in the region of a near-circular gas/material stream of a spouted-bed apparatus onto the particle surface of the material, and the drying and granulation in the gas stream. Furthermore, the invention relates to granules comprising a pesticide, obtainable by said method, where the granules have a roundness of at least 0.85. Combinations of preferred features with other preferred features are encompassed by the present invention.

Granules comprising pesticides are generally known:

WO 2007/048851 discloses solid crop protection compositions comprising a liquid or low-melting polyalkoxylate and a carrier based on relatively high molecular weight sulfonate in the form of fluidized-bed granules.

WO 2008/065051 discloses a method for producing granular solid solutions of sparingly soluble pesticides by atomizing a solution of the pesticide and the matrix auxiliaries, where a fluidized-bed spray granulation can be used for the drying.

DE 2627065 discloses a method for producing solid herbicide granules in which an aqueous solution of a herbicide is introduced into a fluidized bed of particles of a solid diluent.

U.S. Pat. No. 5,883,047 discloses a method for producing granules of crop protection compositions by subjecting an aqueous solution or dispersion to a fluidized-bed granulation.

The known methods for producing granules by means of fluidized-bed methods have various disadvantages. Not very compact granules with low bulk densities are formed. The granules are agglomerate-like, which leads to dusty formulations that are not very abrasion-resistant. Thermally sensitive pesticides such as pyraclostrobin are damaged. The productivity (kg of granules per unit time) is insufficiently high for economical production.

It was therefore an object of the present invention to find a production method for granules which can overcome the aforementioned disadvantages.

The object has been achieved by a method for producing granules comprising a pesticide, comprising the spraying-on of a pesticide-containing spray liquid in the region of a near-circular gas/material stream of a spouted-bed apparatus onto the particle surface of the material, and the drying and granulation in the gas stream.

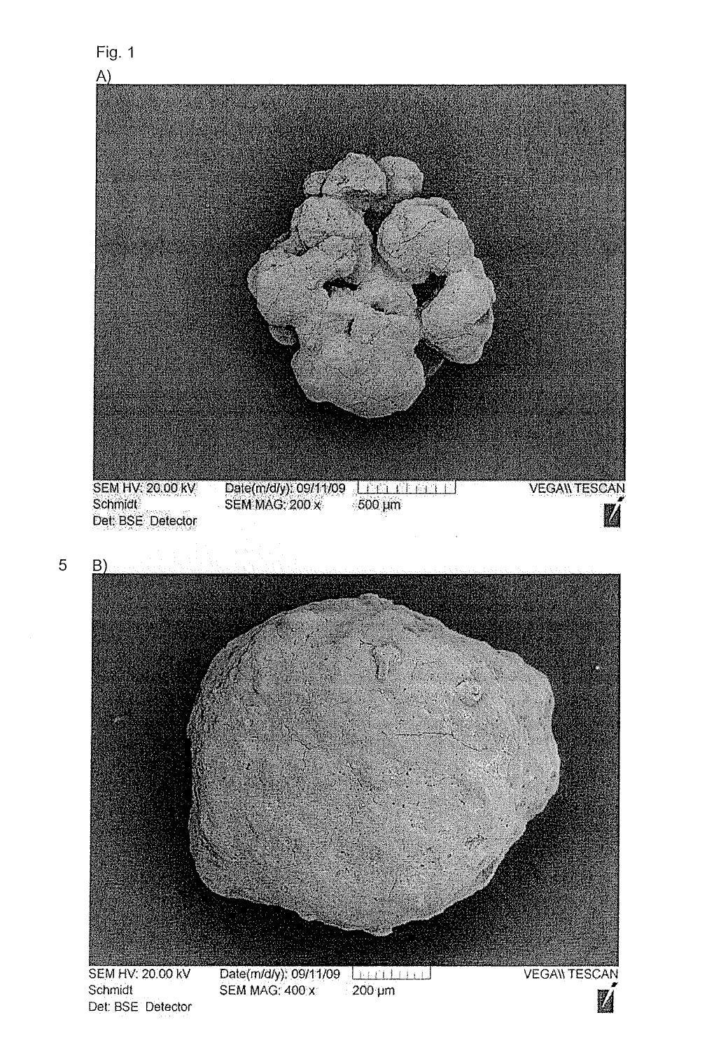

Spouted-bed apparatuses are generally known, for example from DE 10 2004 024 681, WO 2004/101132, US 2005/0152815 or EP 1 325 775. They are commercially available, for example from Glatt Ingenieurtechnik GmbH, Weimar, the model series ProCell. Preference is given to a spouted-bed apparatus as disclosed in FIG. 1 of WO 2007/017159, which is hereby incorporated by reference. The customary mode of function of this spouted-bed apparatus is described on page 7, line 4 to page 12, line 20 and is hereby incorporated by reference. WO 2004/101132 discloses a general method for introducing liquids into a flow of solids of a spouted-bed apparatus, in which the liquid is introduced into the spouted bed via a nozzle.

The near-circular gas/material stream is preferably near-cylindrical. In most cases, it flows here around a longitudinal axis which is preferably approximately parallel to one or more gap openings of the spouted-bed apparatus.

For the granulation of the pesticide-containing spray liquid, a required amount of processing gas is introduced via at least (although also preferably only) one incoming-air chamber (mostly with approximately rectangular cross section and limiting side walls). The introduced processing gas (such as air or nitrogen) has temperatures in the range from −20° C. to 250° C. In the incoming-air chamber, the processing gas is distributed and enters, via one or more (in particular two) (preferably oblong, running approximately parallel to the horizontal) gap openings, into a processing space in the form of one or more (preferably two) gas jets.

The stream of processing gas, which preferably enters the gap opening horizontally, is preferably diverted upwards into the processing space by one or more (preferably two) diverting sections (which may be adjustable and which are preferably designed such that they provide for a curved line of the processing gas from the incoming-stream region approximately perpendicular to the and in the direction of a longitudinal plane of the spouted-bed apparatus through the at least one gap-shaped gap opening and in the outgoing-stream region (mouth region into the processing space) upwards approximately parallel to the longitudinal plane) and in each case flows into the apparatus as a type of free jet. This arrangement makes it possible to establish a particularly uniform particle stream, particularly if the back flow takes place by the particles being retarded by the side walls of the back flow zone and entering the gas stream at the side.

Furthermore, the apparatus cross section can optionally expand in an expansion zone so that the velocity of the processing gas stream is steadily reduced upwards. The gas leaves the apparatus as offgas above the expansion zone via an outgoing-air section, into which optionally at least one dedusting installation, e.g. one or more filter cartridges and/or textile filter elements or the like, can be integrated.

In the processing space, there is an amount of pesticide-containing particles (“material”), which are entrained upwards by the processing gas jet. In the upper region of the processing space and also in the expansion zone located above this, the gas velocity decreases, such that the particles flowing upwards emerge from the gas jet at the side and drop back into the processing space. The processing space is limited in the lower region by one or preferably more (here two) inclined side walls. As a result of this side inclination, the particles are conveyed under the action of gravity via a back flow zone in the direction of the gas inlet gap(s), where they are then entrained again into the processing space by the processing gas. Preferably, a pressure difference can be established by preferred slit-like gas inlet gaps corresponding to process requirements, and thus the uniformity of the gas entry and a reduction in dead zones that may be present can be achieved. The inflow cross section established can preferably be smaller than in the prior art, meaning that the fluidization conditions can be adjusted more precisely.

As a result of this mechanism, a very uniform solids circulation is formed in one or more (preferably two) near-circular (preferably approximately near-cylindrical, i.e. cylindrical or approximately cylindrical) gas/material streams. Here, each near-circular gas/material stream consists of an upwards stream and a back flow in the direction of the processing gas entry. Consequently, even in the case of very small amounts of particles in the processing space, there is a high particle density in the core zone above each diverting section. In this region, one or more spraying nozzles are arranged, which, acting in the same direction as the processing gas jet, spray upwards and serve to introduce the pesticide-containing spray liquid. The temperature of the gas/material stream is in most cases at most 1° C., preferably at most 5° C., and specifically at most 10° C., below the melting point of the pesticide. In a further embodiment, the temperature in the gas/material stream is in most cases 25 to 150° C., preferably 30 to 120° C.

The high particle loading in the core zone results in very advantageous conditions for heat transfer and material transfer in the atomization zone. It also ensures that the liquid deposits as far as possible on the particles and that the latter are thus wetted uniformly on the particle surfaces. The uniform wetting coupled with simultaneously high solids circulation between atomization region and back flow zone(s) ensures that a very uniform liquid film is formed on the material particles. As a result of the solidification process, the liquid hardens and the solid remains on the particle surface. Consequently, the granules grow very uniformly and homogeneously, which leads to a very narrow particle size distribution and to a homogeneous particle structure.

The processing gas introduced into the processing space can discharge some of the particles and also fines material and dust as solid-laden outgoing air from the processing space. To separate off these particles, at least one filter system optionally integrated into the outgoing-air section as dedusting installation or one or more other types of dedusting installations connected downstream of the apparatus can be used. In the case of an integrated dedusting installation, compressed-air pulses, for example, can be used in order to return the retained particles as separated-off solid to the processing space.

In contrast to fluidized-bed apparatuses with integrated filter installations, returning the dust is made easier by the upwardly directed stream of processing gas being substantially localized and consequently the particles to be returned being able to drop reliably outside of the gas jet. The suction effect in the vicinity of the gas inlet gap additionally promotes this mechanism. Alternatively, particles separated off from the outgoing air can be returned to the processing space. For this, one or more feeds of a highly diverse nature can be arranged in the lower region of the inclined side walls. As a result of the high velocity of the processing gas jet in the vicinity of the gas inlet gap(s), the fine particles are sucked in and conveyed to the atomization zone, where they are wetted with liquid and participate in the growth process.

In a preferred embodiment, one or more (preferably two) optionally incorporated guide plates (preferably approximately parallel to the gap opening(s)) can support the gas jet, increase the suction effect and improve the feed of the solids into the atomization zone. Any agglomeration effects that arise are minimized since in the atomization zone very high flow velocities and thus higher forces of separation than in fluidized beds occur. Consequently, particles are separated and grow to give very spherical granules. The flow profile of the processing gas in the processing space also results in fine particles returned to the processing space by the optionally integrated filter installation not dropping back into the atomization zone. This prevents the adhesion of fine particles and agglomerate formation processes resulting therefrom.

For continuous process control, the apparatus can optionally be equipped with one or more different feed systems for solids. As a result, it is possible, for example, to introduce particles into the process which can be obtained by the comminution of for example excessively large granules and/or consist of granules that are too small. These particles then serve as granulation seeds or as starting filling for reducing the start-up time. Moreover, one or more additives which are to be embedded in the granules can be inserted in solid form into the process.

Furthermore, the apparatus can be provided with one or more discharge elements in order to be able to remove particles from the processing space. This can take place, for example, via at least one overflow and/or via at least one volumetric discharge mechanism, a rotary vane device, a grinding/sieving cycle, or a gravity classifier, e.g. a zigzag classifier fed with classifying gas or a riser-tube classifier. The discharge element is preferably a grinding/sieving cycle. Here, the sieving material can be separated via two sieves according to fine material, useful material and coarse material. The coarse material can be passed after grinding in a mill to the sieving again or be passed directly to the processing space of the spouted-bed apparatus.

Optionally, one or more comminution devices can be attached in the processing space, but preferably in the region of the back flow zone on the inclined side wall(s), in order to produce, as a result of comminution, sufficient fine material as seeds for the granule formation process. Furthermore, the one or more back flow zones can optionally be used for the positioning of in each case one or more heaters and/or other heat transfer devices. For example, the apparatus wall can be jacketed in design in order to use this, for example utilizing liquid or gaseous heat-transfer media, for the heating or cooling of the walls. Consequently, it is possible to establish optimum surface temperatures in order to avoid, for example, product depositions.

In the processing space or in the apparatus sections above this, the expansion zone and the outgoing-air section, optionally one or more spray nozzles may be arranged, which preferably spray upwards, but can also partly spray upwards. Here—besides or instead of atomization by the nozzle(s)—the spray liquid can be sprayed in in order, for example through spray-drying/spray-solidification in the apparatus, to produce granulation seeds, especially in the initial phase. Alternatively, via part of the spray devices, additives in the form of organic or inorganic coating agents (in particular release agents) or other components in liquid form can be sprayed in and thus (at least substantially) homogeneously embedded in the granule structure. If the spray nozzle(s) pass the heated incoming-air chamber(s), optionally the liquid-conveying sections can be provided with insulations or one or more different cooling or heating systems in order to prevent damage to the liquid formulation. The spray nozzles used are preferably two-fluid nozzles in which gas and spray liquid are sprayed in simultaneously. The pressure may be at least 1.1 bar, preferably at least 2.0 bar, particularly preferably at least 2.5 bar and in particular at least 3.0 bar. Two-component nozzles are advantageous because they permit a higher solids content and higher viscosity of the spray liquid and can thus lead to a higher throughput. Particularly in the case of dispersant-containing spray liquids, this was an advantage since dispersants increase the viscosity.

The pesticide-containing spray liquid comprises at least one pesticide in dissolved, suspended, emulsified and/or molten form. The pesticide is preferably present in the spray liquid in dissolved, suspended or emulsified form, in particular in suspended or dissolved form. The spray liquid can comprise a solvent, such as water. The viscosity of the spray liquid at 20° C. can be up to 5000 mPas, preferably up 2500 mPas.

The pesticide-containing spray liquid preferably has a solids content of at least 20% by weight, preferably at least 30% by weight and in particular at least 40% by weight. The upper limit of the solids content is governed by the viscosity of the spray liquid, which should be still pumpable. Thus, the spray liquid can have a solids content of up to 70% by weight, preferably up to 65% by weight and in particular up to 60% by weight. The spray liquid comprises in most cases at least 1% by weight, preferably at least 5% by weight and in particular at least 10% by weight, of pesticide. The spray liquid comprises in most cases at least 5% by weight, preferably at least 12% by weight and in particular at least 18% by weight, of dispersant(s).

The pesticide-containing spray liquid preferably comprises at least one dispersant. The dispersant is preferably an anionic surfactant. Suitable dispersants are, for example, anionic surfactants from the group of alkali metal, alkaline earth metal or ammonium salts of sulfonates, sulfates, phosphates or carboxylates. Examples of sulfonates are alkylarylsulfonates, diphenylsulfonates, alpha-olefinsulfonates, lignosulfonates, sulfonates of fatty acids and oils, sulfonates of ethoxylated alkylphenols, sulfonates of condensed naphthalenes, sulfonates of dodecyl and tridecylbenzenes, sulfonates of naphthalenes and alkylnaphthalenes, sulfosuccinates or sulfosuccinamates. Examples of sulfates are sulfates of fatty acid and oils, of ethoxylated alkylphenols, of alcohols, of ethoxylated alcohols, or of fatty acid esters. Examples of phosphates are phosphate esters. Examples of carboxylates are alkyl carboxylates and carboxylated alcohol or alkylphenol ethoxylates. Particular preference is given to alkali metal, alkaline earth metal or ammonium salts of sulfonates, particularly preferably lignosulfonates (such as sodium lignosulfonates) and sulfonates of condensed naphthalenes (such as sodium salt of naphthalenesulfonate-formaldehyde polycondensate). Preferably, the granules comprise at least two dispersants.

The granules comprise usually 5 to 70% by weight of dispersants, preferably 10 to 50% by weight and in particular 20 to 45% by weight. The concentration in the spray solution can be adjusted so that the desired concentration is reached in the granules.

The term pesticide refers to at least one active ingredient selected from the group of fungicides, insecticides, nematicides, herbicides, safeners and/or growth regulators. Preferred pesticides are fungicides, insecticides, herbicides and growth regulators.

Mixtures of pesticides from two or more of the aforementioned classes can also be used. The person skilled in the art is familiar with such pesticides, which can be found, for example, in Pesticide Manual, 14th ed. (2006), The British Crop Protection Council, London.

Suitable fungicides are:

A) Strobilurins:
azoxystrobin, dimoxystrobin, enestroburin, fluoxastrobin, kresoxim-methyl, metominostrobin, orysastrobin, picoxystrobin, pyraclostrobin, pyrametostrobin, pyraoxystrobin, pyribencarb, trifloxystrobin, 2-(ortho((2,5-dimethylphenyloxy-methylene)phenyl)-3-methoxyacrylic acid methyl ester, 2-(2-(3-(2,6-dichlorophenyl)-1-methylallylideneaminooxymethyl)phenyl)-2-methoxyimino-N-methylacetamide;

B) Carboxamides:
carboxanilides: benalaxyl, benalaxyl-M, benodanil, bixafen, boscalid, carboxin, fenfuram, fenhexamid, flutolanil, furametpyr, isopyrazam, isotianil, kiralaxyl, mepronil, metalaxyl, metalaxyl-M (mefenoxam), ofurace, oxadixyl, oxycarboxin, penflufen (N-(2-(1,3-dimethylbutyl)phenyl)-1,3-dimethyl-5-fluoro-1H-pyrazole-4-carboxamide), penthiopyrad, sedaxane, tecloftalam, thifluzamide, tiadinil, 2-amino-4-methylthiazole-5-carboxanilide, N-(3′,4′,5′-trifluorobiphenyl-2-yl)-3-difluoromethyl-1-methyl-1H-pyrazole-4-carboxamide, N-(4′-trifluoromethylthiobiphenyl-2-yl)-3-difluoromethyl-1-methyl-1H-pyrazole-4-carboxamide, N-(2-(1,3,3-trimethylbutyl)phenyl)-1,3-dimethyl-5-fluoro-1H-pyrazole-4-carboxamide;
carboxylic acid morpholides: dimethomorph, flumorph, pyrimorph;
benzamides: flumetover, fluopicolide, fluopyram, zoxamid;
other carboxamides: carpropamid, diclocymet, mandipropamid, oxytetracycline, silthiofam, N-(6-methoxypyridin-3-yl)cyclopropanecarboxamide;

C) Azoles:
triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazol, penconazole, propiconazole, prothioconazole, simeconazole, tebuconazole, tetraconazole, triadimefon, triadimenol, triticonazole, uniconazole;
imidazoles: cyazofamid, imazalil, imazalil sulfate, pefurazoate, prochloraz, triflumizole;
benzimidazoles: benomyl, carbendazim, fuberidazole, thiabendazole;
others: ethaboxam, etridiazole, hymexazol, 2-(4-chlorophenyl)-N-[4-(3,4-dimethoxyphenypisoxazol-5-yl]-2-prop-2-ynyloxyacetamide;

D) Nitrogen-containing heterocyclyl compounds:
pyridines: fluazinam, pyrifenox, 3-[5-(4-chlorophenyl)-2,3-dinnethylisoxazolidin-3-yl]-pyridine, 3-[5-(4-methylphenyl)-2,3-dimethylisoxazolidin-3-yl]pyridine;
pyrimidines: bupirimat, cyprodinil, diflumetorim, fenarimol, ferimzone, mepanipyrim, nitrapyrin, nuarimol, pyrimethanil;
piperazines: triforine;
pyrroles: fludioxonil, fenpiclonil;
morpholines: aldimorph, dodemorph, dodemorph acetate, fenpropimorph, tridemorph;
piperidines: fenpropidin;
dicarboximides: fluorimide, iprodione, procymidone, vinclozolin;
nonaromatic 5-membered ring heterocycles: famoxadone, fenamidone, flutianil, octhilinone, probenazole, S-allyl 5-amino-2-isopropyl-3-oxo-4-ortho-tolyl-2,3-dihydropyrazole-1-thiocarboxylate;
others: acibenzolar-S-methyl, amisulbrom, anilazine, blasticidin-S, captafol, captan, chinomethionat, dazomet, debacarb, diclomezine, difenzoquat, difenzoquat methylsulfate, fenoxanil, folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxypyrimidin-2-yl)-2-methyl-1H-benzoimidazole, 5-chloro-7-(4-methylpiperidin-1-yl)-6-(2,4,6-trifluorophenyl)[1,2,4]triazolo[1,5-a]pyrimidine, 5-ethyl-6-octyl[1,2,4]triazolo[1,5-a]pyrimidin-7-ylamine;

E) Carbamates and dithiocarbamates:
thio- and dithiocarbamates: ferbam, mancozeb, maneb, metam, methasulphocarb, metiram, propineb, thiram, zineb, ziram;
carbamates: diethofencarb, benthiavalicarb, iprovalicarb, propamocarb, propamocarb hydrochloride, valiphenal, N-(1-(1-(4-cyanophenyl)ethanesulfonyl)but-2-yl)carbamic acid 4-fluorophenyl ester;

F) Other fungicides:
guanidines: dodine, dodine free base, guazatin, guazatin acetate, iminoctadine, iminoctadine triacetate, iminoctadine tris(albesilate);
antibiotics: kasugamycin, kasugamycin hydrochloride hydrate, polyoxins, streptomycin, validamycin A;
nitrophenyl derivatives: binapacryl, dicloran, dinobuton, dinocap, nitrothal-isopropyl, tecnazene;
organometallic compounds: fentin salts such as, for example, fentin acetate, fentin chloride, fentin hydroxide;
sulfur-containing heterocyclyl compounds: dithianon, isoprothiolane;
organophosphorus compounds: edifenphos, fosetyl, fosetyl-aluminum, iprobenfos, phosphorous acid and its salts, such as, for example, calcium hydrogen-phosphonates, pyrazophos, tolclofos-methyl;
organochlorine compounds: chlorothalonil, dichlofluanid, dichlorphen, flusulfamide, hexachlorobenzene, pencycuron, pentachlorophenol and its salts, phthalide, quintozene, thiophanate-methyl, tolylfluanid, N-(4-chloro-2-nitrophenyl)-N-ethyl-4-methylbenzenesulfonamide;
inorganic active ingredients: phosphorous acid and its salts, Bordeaux mixture, copper salts such as, for example, copper acetate, copper hydroxide, copper oxychloride, basic copper sulfate, sulfur;
others: biphenyl, bronopol, cyflufenamid, cymoxanil, diphenylamine, metrafenone, mildiomycin, oxine-copper, prohexadione-calcium, spiroxamine, tolylfluanid, N-(cyclopropylmethoxyimino-(6-difluoromethoxy-2,3-difluorophenyl)methyl)-2-phenyl-acetamide, N′-(4-(4-chloro-3-trifluoromethylphenoxy)-2,5-dimethylphenyl)-N-ethyl-N-methylformamidine, N′-(4-(4-fluoro-3-trifluoromethylphenoxy)-2,5-dimethylphenyl)-N-ethyl-N-methylformamidine, N′-(2-methyl-5-trifluoromethyl-4-(3-trimethylsilanyl-propoxy)phenyl)-N-ethyl-N-methylformamidine, N′-(5-difluoromethyl-2-methyl-4-(3-trimethylsilanylpropoxy)phenyl)-N-ethyl-N-methylformamidine, 2-{1-[2-(5-methyl-3-trifluoromethylpyrazol-1-yl)acetyl]piperidin-4-yl}thiazole-4-carboxylic acid methyl-(1,2,3,4-tetrahydronaphthalen-1-yl)amide, 2-{1-[2-(5-methyl-3-trifluoromethyl-pyrazol-1-ypacetyl]piperidin-4-yl}thiazole-4-carboxylic acid methyl-(R)-1,2,3,4-tetrahydronaphthalen-1-ylamide, acetic acid 6-tert-butyl-8-fluoro-2,3-dimethylquinolin-4-yl ester, methoxyacetic acid 6-tert-butyl-8-fluoro-2,3-dimethylquinolin-4-yl ester, N-methyl-2-{1-[2-(5-methyl-3-trifluoromethyl-1H-pyrazol-1-yl)acetyl]piperidin-4-yl}-N-[(1R)-1,2,3,4-tetrahydronaphthalen-1-yl]-4-thiazolecarboxamide.

Suitable growth regulators are:

Abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfid, indole-3-acetic acid, maleic hydrazide, mefluidide, mepiquat (mepiquat chloride), metconazole, naphthaleneacetic acid, N-6-benzyladenine, paclobutrazol, prohexadione (prohexadione-calcium), prohydrojasmon, thidiazuron, triapenthenol, tributyl phosphorotrithioate, 2,3,5-triiodobenzoic acid, trinexapac-ethyl and uniconazole.

Suitable herbicides are:
acetamides: acetochlor, alachlor, butachlor, dimethachlor, dimethenamid, flufenacet, mefenacet, metolachlor, metazachlor, napropamide, naproanilide, pethoxamid, pretilachlor, propachlor, thenylchlor;
amino acid analogs: bilanafos, glyphosate, glufosinate, sulfosate;
aryloxyphenoxypropionates: clodinafop, cyhalofop-butyl, fenoxaprop, fluazifop, haloxyfop, metamifop, propaquizafop, quizalofop, quizalofop-P-tefuryl;
bipyridyls: diquat, paraquat;
carbamates and thiocarbamates: asulam, butylate, carbetamide, desmedipham, dimepiperate, eptam (EPTC), esprocarb, molinate, orbencarb, phenmedipham, prosulfocarb, pyributicarb, thiobencarb, triallate;
cyclohexanediones: butroxydim, clethodim, cycloxydim, profoxydim, sethoxydim, tepraloxydim, tralkoxydim;
dinitroanilines: benfluralin, ethalfluralin, oryzalin, pendimethalin, prodiamine, trifluralin;
diphenyl ethers: acifluorfen, aclonifen, bifenox, diclofop, ethoxyfen, fomesafen, lactofen, oxyfluorfen;
hydroxybenzonitriles: bromoxynil, dichlobenil, ioxynil;
imidazolinones: imazamethabenz, imazamox, imazapic, imazapyr, imazaquin, imazethapyr;
phenoxyacetic acids: clomeprop, 2,4-dichlorophenoxyacetic acid (2,4-D), 2,4-DB, dichlorprop, MCPA, MCPA-thioethyl, MCPB, mecoprop;
pyrazines: chloridazon, flufenpyr-ethyl, fluthiacet, norflurazon, pyridate;
pyridines: aminopyralid, clopyralid, diflufenican, dithiopyr, fluridone, fluroxypyr, picloram, picolinafen, thiazopyr;
sulfonylureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propyl-imidazo[1,2-b]pyridazin-3-yl)sulfonyl)-3-(4,6-dimethoxypyrimidin-2-yl)urea;
triazines: ametryn, atrazine, cyanazine, dimethametryn, ethiozine, hexazinone, meta-mitron, metribuzin, prometryn, simazine, terbuthylazine, terbutryn, triaziflam;
ureas: chlorotoluron, daimuron, diuron, fluometuron, isoproturon, linuron, methabenzthiazuron,tebuthiuron;
other acetolactate synthase inhibitors: bispyribac-sodium, cloransulam-methyl, diclosulam, florasulam, flucarbazone, flumetsulam, metosulam, ortho-sulfamuron, penoxsulam, propoxycarbazone, pyribambenz-propyl, pyribenzoxim, pyriftalide, pyriminobac-methyl, pyrimisulfan, pyrithiobac, pyroxasulfone, pyroxsulam;
others: amicarbazone, aminotriazole, anilofos, beflubutamid, benazolin, bencarbazone, benfuresate, benzofenap, bentazone, benzobicyclon, bromacil, bromobutide, butafenacil, butamifos, cafenstrole, carfentrazone, cinidon-ethlyl, chlorthal, cinmethylin, clomazone, cumyluron, cyprosulfamide, dicamba, difenzoquat, diflufenzopyr, Drechslera monoceras, endothal, ethofumesate, etobenzanid, fentrazamide, flumiclorac-pentyl, flumioxazin, flupoxam, fluorochloridone, flurtamone, indanofan, isoxaben, isoxaflutole, lenacil, propanil, propyzamide, quinclorac, quinmerac, mesotrione, methylarsenic acid, naptalam, oxadiargyl, oxadiazon, oxaziclomefone, pentoxazone, pinoxaden, pyraclonil, pyraflufen-ethyl, pyrasulfotol, pyrazoxyfen, pyrazolynat, quinoclamine, saflufenacil, sulcotrione, sulfentrazone, terbacil, tefuryltrione, tembotrione, thiencarbazone, topramezone, 4-hydroxy-3-[2-(2-methoxy-ethoxymethyl)-6-trifluoromethylpyridine-3-carbonyl]bicyclo[3.2.1]oct-3-en-2-one, ethyl (3-[2-chloro-4-fluoro-5-(3-methyl-2,6-dioxo-4-trifluoromethyl-3,6-dihydro-2H-pyrimidin-1-yl)phenoxy]pyridin-2-yloxy)acetate, methyl 6-amino-5-chloro-2-cyclopropylpyrimidin-4-carboxylate, 6-chloro-3-(2-cyclopropyl-6-methylphenoxy)pyridazin-4-ol, 4-amino-3-chloro-6-(4-chlorophenyl)-5-fluoropyridine-2-carboxylic acid, methyl 4-amino-3-chloro-6-(4-chloro-2-fluoro-3-methoxyphenyl)pyridine-2-carboxylate and methyl 4-amino-3-chloro-6-(4-chloro-3-dimethylamino-2-fluorophenyl)pyridine-2-carboxylate.

Suitable insectides are:
Organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalo-thrin, permethrin, prallethrin, pyrethrin I and II, resmethrin, silafluofen, tau-fluva-linate, tefluthrin, tetramethrin, tralomethrin, transfluthrin, profluthrin, dimefluthrin;
insect growth inhibitors: a) chitin synthesis inhibitors: benzoylureas: chlorfluazuron, cyramazine, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitiors: spirodiclofen, spiromesifen, spirotetramate;
nicotine receptor agonists/antagonists: clothianidin, dinotefuran, imidacloprid, thiamethoxam, nitenpyram, acetamiprid, thiacloprid, 1-(2-chlorothiazol-5-ylmethyl)-2-nitrimino-3,5-dimethyl[1,3,5]triazinane;
GABA antagonists: endosulfan, ethiprole, fipronil, vaniliprole, pyrafluprole, pyriprole, 5-amino-1-(2,6-dichloro-4-methylphenyl)-4-sulfinamoyl-1H-pyrazole-3-thiocarboxamide;
macrocyclic lactones: abamectin, emamectin, milbemectin, lepimectin, spinosad, spinetoram;
mitochondrial electron transport chain inhibitor (METI) I acaricides: fenazaquin, pyridaben, tebufenpyrad, tolfenpyrad, flufenerim;
METI II and III substances: acequinocyl, fluacyprim, hydramethylnon;
decouplers: chlorfenapyr;
inhibitors of oxidative phosphorylation: cyhexatin, diafenthiuron, fenbutatin oxide, propargite;
insect molting inhibitors: cryomazine;
mixed-function oxidase inhibitors: piperonyl butoxide;
sodium channel blockers: indoxacarb, metaflumizone;
others: benclothiaz, bifenazate, cartap, flonicamid, pyridalyl, pymetrozin, sulfur, thiocyclam, flubendiamide, chlorantraniliprole, cyazypyr (HGW86); cyenopyrafen, flupyrazofos, cyflumetofen, amidoflumet, imicyafos, bistrifluron and pyrifluquinazon.

Preferred pesticides are alpha-cypermethrin, ametoctradin, bentazon, benthiavalicarb-isopropyl, boscalid, calcium hydrogenphosphonate, carbendazim, chloridazon, chlorothalonil, cinidon-ethyl, cyclosulfamuron, cymoxanil, dicamba, diflufenzopyr, dimethomorph, dimoxystrobin, dithianon, diuron, fipronil, fluquinconazole, folpet, fosetyl-Al, imazamox, imazapic, imazapyr, imazethapyr, iprodione, isoproturon, isoxadifen-ethyl, kresoxim-methyl, mancozeb, mecoprop-P, mepiquat-chloride, metiram, myclobutanil, nicosulfuron, picolinafen, profoxydim, prohexadione-calcium, propoxycarbazone-sodium, pyraclostrobin, quinclorac, saflufenacil, sulfosulfuron, sulfur, tebufenpyrad, thiram, tritosulfuron or vinclozolin. Particularly preferred pesticides are boscalid and pyraclostrobin, in particular boscalid.

The granules can comprise 1 to 99% by weight of pesticide, preferably 20 to 80% by weight, particularly preferably 30 to 70% by weight, and in particular 40 to 70% by weight. The concentration in the spray solution can be adjusted so that the desired concentration is achieved in the granules.

The present invention also relates to granules comprising a pesticide obtainable by the method according to the invention, where the granules have a roundness of at least 0.85, preferably at least 0.88, particularly preferably at least 0.90, and in particular at least 0.94. The granules are preferably obtained by the method according to the invention.

The roundness describes the ratio between the area (A) of a particle image and the circumference (U). The roundness (R) is calculated from R=4πA/U². According to this, a spherical particle would have a roundness close to one whereas a serrated, irregular particle image would have a roundness close to zero. The roundness can be determined with the help of automated image analysis techniques, for example using the optical particle measuring system CAMSIZER® from Retsch Technology, which permits the simultaneous determination of particle size and particle shape (such as roundness) by means of digital image analysis.

The particle size distribution D50 is in the range from 50 to 5000 μm, preferably 100 to 1000 μm. It can be determined by means of digital image processing, for example using a Camsizer® from Retsch Technology.

The present invention offers many advantages over the prior art: in the experiments, the spouted-bed method had considerably higher process stability than a comparable fluidized-bed method, i.e. various parameters could be changed or optimized without the granulation process collapsing. Very compact granules with high bulk densities are formed. The granules are spherical, in contrast to the rather agglomerate-like granules from fluidized-bed methods. The spherical form results in granules which are clearly more abrasion-resistant and largely dust-free. Moreover, they exhibit better pourability and have a more constant bulk density, as a result of which the dosability is considerably simplified. Even thermally sensitive pesticides such as pyraclostrobin could be granulated without thermal damage. The productivity (kg of granule per unit time) is considerably higher than in the fluidized-bed method. This was possible as a result of an increased solids content and flow of the spray liquid, an increased incoming-air temperature and/or an increased incoming-air volume flow rate.

The examples below illustrate the invention without limiting it.

### EXAMPLES

Apparatus and Method

All of the experiments were carried out on a laboratory facility ProCell 5 from Glatt Ingenieurtechnik GmbH (Weimar). The spouted-bed insert “ProCell” and the standard fluidized-bed insert “GF” were available. The GF insert is a slightly conical fluidized-bed insert with three possible nozzle positions. Here, spraying from above, below and through the floor is possible. Additionally, a Wurster tube and a floor with corresponding perforation can be incorporated. In the case of the ProCell spouted fluidized-bed insert, the two parallel air gaps are located on the underside of a rectangular hopper. The nozzle is arranged in the middle between these air gaps and is used for spraying from below. The option topspray is present.

The continuous and classifying discharge is realized using a zigzag classifier. For both inserts, nozzles from the series 970 S4 from Düsen-Schlick GmbH (Untersiemau/Coburg) are used and spraying is from bottom to top. Ambient air was used as processing gas and peripheral compressed air as classifying and nozzle gas.

The solvent was demineralized water.

Prior to each experiment, the facility was preheated to the desired temperature of the fluidized bed and all of the necessary facility parts were started up. After introducing the initial charge of granules, incoming-air temperature and incoming-air volume flow rate were increased to the desired values. The rates of increase were limited here to a maximum of 1 K/min and 1 m³/h/min so that the bed can follow the new process parameters. The bed temperature was kept constant here by increasing the suspension mass stream. Through continuous stirring, settling of the spray liquid in the form of the suspension was prevented.

Analysis:

The particle size distribution was determined using a CAMSIZER® from Retsch Technology GmbH.

The loose bulk density was determined by weighing 100 ml of loose filled granules in a measuring cylinder. The tamped bulk density was determined by allowing a measuring cylinder to drop 20 times from a defined height.

The dispersibility in accordance with the CIPAC method MT-174 was determined as follows: with continuous stirring (300 rpm), 9 g of granules are dispersed in 900 ml of hard water (19.2° German hardness) in a beaker. After stirring for 1 min, the stirrer is switched off. After a further minute, down to 90 ml is sucked off from above. The residue is dried to constant weight at 70° C. The dispersibility (%) is calculated from 111.1 * (initial weight−residue)/initial weight. In the sucked-off liquid, the amount of solid=initial weight−residue. Since only 90% of the liquid has been drawn off, the drawn-off solid has to be extrapolated to the 100% liquid: (10/9*90%=100%); this gives the factor 1.111.

### Example 1

The spray liquid with 55% by weight solids content was prepared from 27.5% by weight of boscalid, 5.5% by weight of ammonium sulfate, 0.4% by weight of silicone-containing antifoam and 22% by weight of dispersant (mixture of two sulfonates) in demineralized water by stirring a suspension was prepared (viscosity 215 mPas at 20° C.). Spray liquids with a lower solids content were diluted accordingly. Boscalid is a fungicide with a melting point of 143° C. and a solubility in water of 6 mg/l. The process conditions are listed in Table 1 and the product analysis in Table 2.

Comparative Experiments:

For comparison, the spray liquid was granulated in the fluidized bed (“C”, Table 1). Starting from C0, individual parameters of the comparison experiment were changed. Increasing the incoming-air temperature from 150 to170° C. led to the collapse of the fluidized bed due to agglomerated particles. The fluidized bed likewise collapsed when the bed temperature was reduced from 75 to 60° C. When the volume flow rate of the incoming air was increased from 120 to 160 m³/h, the experiment also had to be terminated since the particles in the fluidized bed were spun too far upwards up to the cover of the apparatus. As the solids content was raised from 45 to 55% by weight, or as the flow rate of spray liquid was raised from 58 to 230 g/min, the fluidized bed likewise collapsed.

TABLE 1
Process conditions

| | | | Incoming-air | | Spray | |
|---|---|---|---|---|---|---|
| | Incoming- | Bed | volume flow | Nozzle gas | liq. | Spray liq. |
| | air temp. | temp. | rate | pressure | SC^{b)} | fow rate |
| No. | [° C.] | [° C.] | [m³/h] | [bar] | [%] | [g/min] |
| C^{a)} | 150 | 75 | 112 | 2 | 45 | 58 |
| 1 | 150 | 75 | 112 | 2 | 44 | 70 |
| 2 | 170 | 75 | 112 | 2 | 45 | 99 |
| 3 | 170 | 60 | 160 | 6 | 55 | 235 |
| 4 | 170 | 60 | 160 | 6 | 55 | 230 |

^{a)}Comparative experiment, not according to the invention, by means of fluidized bed.
^{b)}Solids content of the spray liquid.

TABLE 2
Analysis of the granules

| | Bulk density | Bulk density | | |
|---|---|---|---|---|
| | loose | tamped | D 50 | |
| No. | [g/l] | [g/l] | [μm] | Dispersibility |
| C | 676 | 743 | 547 | 100% |
| 2 | — | — | 495 | 99% |
| 3 | — | — | 618 | 100% |
| 4 | 771 | 847 | 482 | 100% |
| 5 | 710 | 798 | 477 | 100% |

Scanning Electron Micrographs (SEM):

FIG. 1 shows scanning electron micrographs of granules from comparative experiment C (FIG. 1A) and from experiment 3 (FIG. 1B). Whereas the fluidized-bed granules from the comparative experiment C were shaped very irregularly with large furrows, the spouted-bed granules from experiment 3 were shaped like spheres with a smooth surface.

### Example 2

The spray liquid with 45% by, weight solids content was prepared from 12.0% by weight of boscalid, 3.0% by weight of pyraclostrobin, 4.5% by weight of ammonium sulfate, 3.0% by weight, of inorganic carrier material, 0.4% by weight of silicone-containing antifoam and 15% of weight, of dispersant (mixture of a plurality of sulfates) in demineralized water by stirring a suspension was prepared (viscosity 44 mPas at 20° C.). Spray liquids with a lower solids content were diluted accordingly.

Pyraclostrobin is a fungicide with a melting point of 64° C. and a solubility in water of 2 mg/l. The process conditions are listed in Table 3 and the product analysis in Table 4.

Comparative Experiments:

For comparison, the spray liquid was granulated in the fluidized bed (“C”, Table 3). Starting from C, individual parameters of the comparative experiment were changed. Increasing the incoming-air temperature from 100 to 120° C. led to the collapse of the fluidized bed due to agglomerated particles. As the solids content was raised from 42 to 45% by weight, or as the flow rate of spray liquid was raised from 58 to 121 g/min, the fluidized bed likewise collapsed.

TABLE 3
Process conditions

| | | | Incoming-air | Nozzle | | |
|---|---|---|---|---|---|---|
| | Incoming- | Bed | volume | gas | Spray | Spray liq. |
| | air temp. | temp. | stream | pressure | liq. SC^{b)} | flow |
| No. | [° C.] | [° C.] | [m³/h] | [bar] | [%] | [g/min] |
| C^{a)} | 100 | 49 | 144 | 2.5-4 | 42 | 85 |
| 1 | 100 | 49 | 144 | 3.5-4 | 42 | 80 |
| 2^{c)} | 130 | 47 | 145 | 4.5-7 | 45 | 133 |
| 3 | 120 | 47 | 145 | 4-6.8 | 45 | 121 |

^{a)}Comparative experiment, not according to the invention, by means of fluidized bed.
^{b)}Solids content of the spray liquid.
^{c)}With cooling of the side walls of the spouted-bed apparatus to 20° C.

TABLE 4
Analysis of the granules

| | Bulk density | Bulk density | | |
|---|---|---|---|---|
| | loose | stamped | D 50 | |
| No. | [g/l] | [g/l] | [μm] | Dispersibility |
| C | 617 | 701 | 369 | 100% |
| 1 | — | — | 398 | — |
| 2 | 857 g/l | 942 g/l | 471 | 100% |
| 3 | 856 g/l | 941 g/l | 491 | 98% |

Scanning Electron Micrographs (SEM):

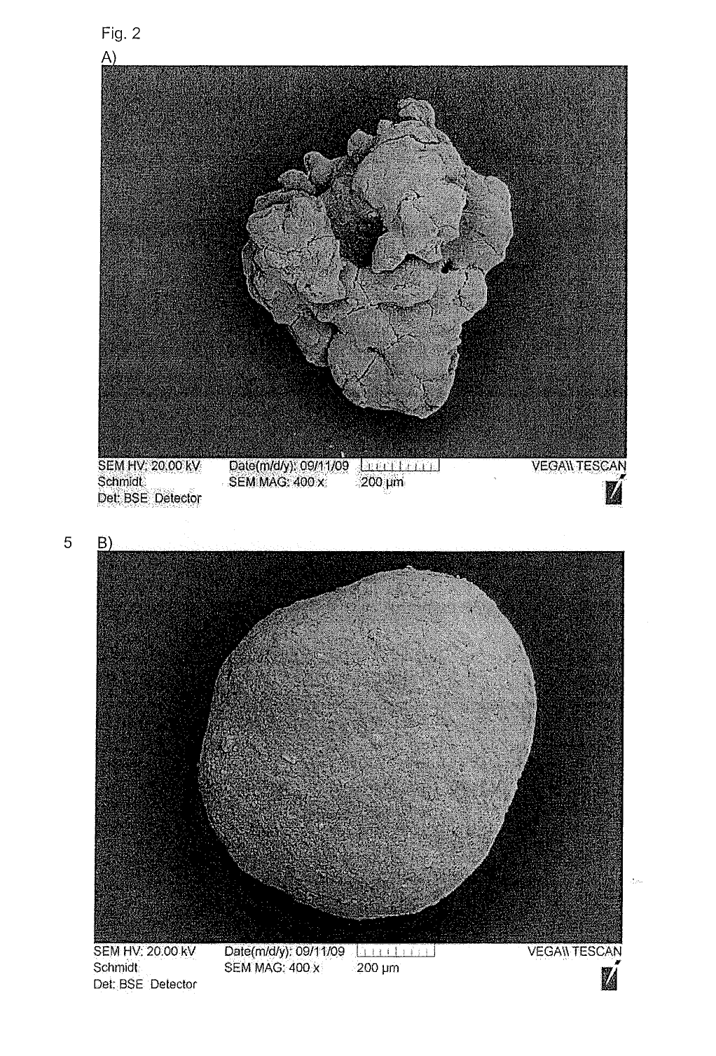

FIG. 2 shows scanning electron micrographs of granules from comparative experiment C (FIG. 2A) and from experiment 3 (FIG. 2B). Whereas the fluidized-bed granules were shaped very irregularly with large furrows, the spouted-bed granules from experiment 3 were shaped like spheres with a smooth surface.

1-11. (canceled)

12. A method for producing granules comprising a pesticide, comprising spraying a pesticide-containing spray liquid onto a particle surface of a material in the region of a near-circular gas/material stream of a spouted-bed apparatus, drying and granulating the material, wherein the material is pesticide-containing particles.

13. The method of claim 12, where the temperature of the gas/material stream is at most 1° C. below the melting point of the pesticide.

14. The method of claim 12, where the pesticide-containing spray liquid has a solids content of at least 20% by weight.

15. The method of claim 12, where the pesticide-containing spray liquid comprises a dispersant.

16. The method of claim 12, where the pesticide-containing spray liquid has a solids content of at least 30% by weight.

17. The method of claim 15, where the dispersant is an anionic surfactant.

18. The method of claim 15, where the granules comprise 10 to 70% by weight of the dispersant.

19. The method of claim 12, where the granules comprise 20 to 99% by weight of the pesticide.

20. The method of claim 12, where the granules comprise at least 30% by weight of the pesticide.

21. The method according to claim 12, where the pesticide is alpha-cypermethrin, ametoctradin, bentazon, benthiavalicarb-isopropyl, boscalid, calcium hydrogenphosphonate, chloridazon, chlorothalonil, cinidon-ethyl, cyclosulfamuron, cymoxanil, dicamba, diflufenzopyr, dimethomorph, dimoxystrobin, dithianon, diuron, fipronil, fluquinconazole, folpet, fosetyl-AI, imazamox, imazapic, imazapyr, imazethapyr, iprodione, isoproturon, isoxadifen-ethyl, kresoxim-methyl, mancozeb, mecoprop-P, mepiquat-chloride, metiram, myclobutanil, nicosulfuron, picolinafen, profoxydim, prohexadione-calcium, propoxycarbazone-sodium, pyraclostrobin, quinclorac, saflufenacil, sulfosulfuron, sulfur, tebufenpyrad, thiram, tritosulfuron or vinclozolin.

22. The method of claim 12, further comprising optionally embedding the granules with one or more additives in solid form.

23. The method of claim 13, where the pesticide-containing spray liquid has a solids content of at least 20% by weight.

24. A granule comprising a pesticide obtainable by the method of claim 12, where the granule has a roundness of at least 0.85.

25. The granule of claim 24, where the pesticide is alpha-cypermethrin, ametoctradin, bentazon, benthiavalicarb-isopropyl, boscalid, calcium hydrogenphosphonate, chloridazon, chlorothalonil, cinidon-ethyl, cyclosulfamuron, cymoxanil, dicamba, diflufenzopyr, dimethomorph, dimoxystrobin, dithianon, diuron, fipronil, fluquinconazole, folpet, fosetyl-AI, imazamox, imazapic, imazapyr, imazethapyr, iprodione, isoproturon, isoxadifen-ethyl, kresoxim-methyl, mancozeb, mecoprop-P, mepiquat-chloride, metiram, myclobutanil, nicosulfuron, picolinafen, profoxydim, prohexadione-calcium, propoxycarbazone-sodium, pyraclostrobin, quinclorac, saflufenacil, sulfosulfuron, sulfur, tebufenpyrad, thiram, tritosulfuron or vinclozolin.

26. The granule of claim 24, where the pesticide is boscalid or pyraclostrobin.

27. The granule of claim 24, where the granule comprises 20 to 99% by weight of pesticide.

28. The granule of claim 24, where optionally one or more additives in solid form are embedded in the granule.

29. The granule of claim 24, where the granule comprises 10 to 70% by weight of a dispersant.

30. The granule of claim 29, where the dispersant is an anionic surfactant.

31. The granule of claim 24, where the granule comprises at least 30% by weight of the pesticide.
